(19) United States
(12) Patent Application Publication
(10) Pub. No.: US 2019/0249859 A1
(43) Pub. Date: Aug. 15, 2019

(54) Intelligent Variable Frequency Laser Rain

(71) Applicant: Weizhao LU, Shenzhen (CN)

(72) Inventor: Weizhao LU, Shenzhen (CN)

(21) Appl. No.: 15/893,574

(22) Filed: Feb. 9, 2018

(51) Int. Cl. F21V 31/00; F21V 13/04; F21V 15/01; F21S 10/06; F21V 14/04

(52) U.S. Cl. CPC F21V 31/005; F21V 13/04; F21W 2131/406; F21S 10/063; F21V 14/04; F21V 15/01

(57) ABSTRACT

The invention relates to an intelligent variable frequency laser rain, including a back cover, a gluey shell, a radiator and a front cover. A button back cover is arranged at the right end of a button. The button back cover is connected with a master control board. The back cover and the gluey shell are fixedly connected through a plurality of screws. A rubber plug is arranged on the screws. A laser beam is reflected through the lenses and projected onto the grating to form a plurality of laser beams. The stepping motor drives the plastic mirror wheel to rotate so that the laser beams move from top to bottom. When the laser beam reaches the bottom, the laser beam is projected onto the next lens to start the process of the next laser beam from top to bottom, thereby finally realizing a unique visual effect of laser raining.

### TECHNICAL FIELD

The present disclosure relates to the field of laser lamps, and more specifically, to an intelligent variable frequency laser rain.

### BACKGROUND

Stage light is also called as “stage lighting”, abbreviated as “light”, and is one of modeling means of stage art. By using a stage light device (such as an illuminating lamp, a slide projector, a control system, etc.) and a technical means, with the development of a plot, light colors and change of the light colors are used to show an environment and exaggerate an atmosphere, highlight a central figure, create a sense of space of the stage, shape an external image of stage performance and provide necessary light effects (such as wind, rain, cloud, water and lightning).

A laser device is needed by the stage light, and is used to simulate a raining effect. But the existing light device is simple in design, cannot realize intelligent variable frequency control, and has a poor simulation effect which influences a stage effect. Therefore, an intelligent variable frequency laser rain is provided by those skilled in the art to solve problems proposed in the above background.

### SUMMARY

The purpose of the present disclosure is to provide an intelligent variable frequency laser rain to solve problems proposed in the above background.

To achieve the above purpose, the present disclosure provides the following technical solution:

An intelligent variable frequency laser rain comprises a back cover, a gluey shell, a radiator and a front cover, wherein a contact and a button are arranged on the back cover; the button is arranged in the middle of the back cover; a button back cover is arranged at the right end of the button; the button back cover is connected with a master control board; the back cover and the gluey shell are fixedly connected through a plurality of screws A; a rubber plug is arranged on the screws A; a waterproof rubber ring is arranged at the right end of the gluey shell; an elastic sheet is arranged between the waterproof rubber ring and the gluey shell; the radiator is arranged at the right end of the gluey shell; a supporting frame A and a supporting frame B are arranged in the radiator; a rubber gear is arranged on the supporting frame A; the rubber gear is connected with a motor; a bearing is arranged on the supporting frame A; the bearing is fixedly connected with the supporting frame A through a screw C; a mirror wheel is arranged on the bearing; a plurality of lenses are arranged on the mirror wheel; the mirror wheel is fixedly connected with the supporting frame B; a reflecting lens bracket is arranged in the radiator; a reflecting lens is arranged on the reflecting lens bracket; an aurora is arranged at the left side of the reflecting lens bracket; the front cover is arranged at the right end of the radiator; and a grating is arranged in the front cover.

As a further solution of the present disclosure, a waterproof rubber ring is arranged between the radiator and the front cover.

As a still further solution of the present disclosure, the radiator and the front cover are fixedly connected through a screw B and a screw D.

As a still further solution of the present disclosure, corresponding gears are arranged on the rubber gear and the mirror wheel.

As a still further solution of the present disclosure, a plurality of wrinkled raised lines are arranged on the radiator.

As a still further solution of the present disclosure, the motor is configured as a stepping motor.

Compared with the prior art, the present disclosure has the technical effects:

The present disclosure is simple and reasonable in structural design, is convenient and quick in operation and is high in practicality. The device is used to simulate a raining effect to realize a unique visual effect. A plurality of lenses are attached to a circular plastic mirror wheel, and a stepping motor drives the plastic mirror wheel to form rotation. A laser beam is reflected through the lenses and projected onto the grating to form a plurality of laser beams. The stepping motor drives the plastic mirror wheel to rotate so that the laser beams move from top to bottom. When the laser beam reaches the bottom, the laser beam is projected onto the next lens to start the process of the next laser beam from top to bottom, thereby finally realizing a unique visual effect of laser raining.

### DESCRIPTION OF DRAWINGS

FIG. 1 is a structural schematic diagram of an intelligent variable frequency laser rain.

In the figure: 1—contact; 2—rubber plug; 3—screw A; 4—button; 5—back cover; 6—button back cover; 7—master control board; 8—gluey shell; 9—screw C; 10—bearing; 11—supporting frame A; 12—rubber gear; 13—mirror wheel; 14—motor; 15—lens; 16—supporting frame B; 17—waterproof rubber ring; 18—screw B; 19—screw D; 20—radiator; 21—reflecting lens; 22—reflecting lens bracket; 23—aurora; 24—elastic sheet; 25—grating; and 26—front cover.

### DETAILED DESCRIPTION

The technical solutions in the embodiments of the present disclosure will be clearly and fully described below in combination with the drawings in the embodiments of the present disclosure. Apparently, the described embodiments are merely part of the embodiments of the present disclosure, not all of the embodiments. Based on the embodiments in the present disclosure, all other embodiments obtained by those ordinary skilled in the art without contributing creative labor will belong to the protection scope of the present disclosure.

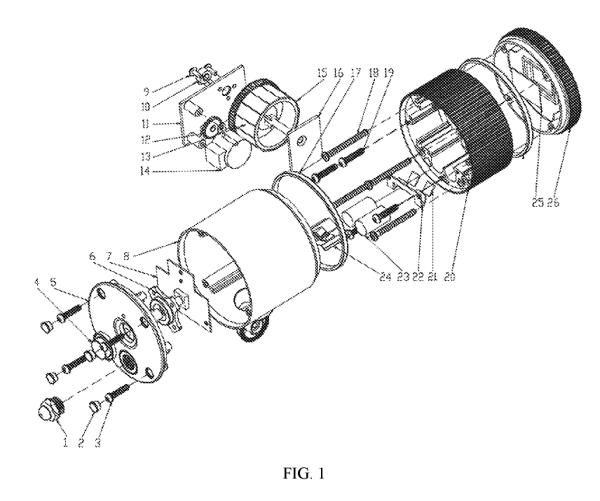

By referring to FIG. 1, in embodiments of the present disclosure, an intelligent variable frequency laser rain comprises a back cover 5, a gluey shell 8, a radiator 20 and a front cover 27, wherein a contact 1 and a button 4 are arranged on the back cover 5; the button 4 is arranged in the middle of the back cover 5; a button back cover 6 is arranged at the right end of the button 4; the button back cover 6 is connected with a master control board 7; the back cover 5 and the gluey shell 8 are fixedly connected through a plurality of screws A3; a rubber plug 2 is arranged on the screws A3; a waterproof rubber ring 25 is arranged at the right end of the gluey shell 8; an elastic sheet 24 is arranged between the waterproof rubber ring 25 and the gluey shell 8; the radiator 20 is arranged at the right end of the gluey shell 8; a supporting frame A11 and a supporting frame B16 are arranged in the radiator 20; a rubber gear 12 is arranged on the supporting frame A11; the rubber gear 12 is connected with a motor 14; a bearing 10 is arranged on the supporting frame A11; the bearing 10 is fixedly connected with the supporting frame A11 through a screw C9; a mirror wheel 13 is arranged on the bearing 10; a plurality of lenses 15 are arranged on the mirror wheel 13; the mirror wheel 13 is fixedly connected with the supporting frame B16; a reflecting lens bracket 22 is arranged in the radiator 20; a reflecting lens 21 is arranged on the reflecting lens bracket 22; an aurora 23 is arranged at the left side of the reflecting lens bracket 22; the front cover 26 is arranged at the right end of the radiator 20; and a grating 25 is arranged in the front cover 26.

A waterproof rubber ring (17 is arranged between the radiator 20 and the front cover 26.

The radiator 20 and the front cover 26 are fixedly connected through a screw B18 and a screw D19.

Corresponding gears are arranged on the rubber gear 12 and the mirror wheel 13.

A plurality of wrinkled raised lines are arranged on the radiator 20.

The motor 14 is configured as a stepping motor.

The present disclosure has the working principle:

The present disclosure relates to an intelligent variable frequency laser rain. The device is used to simulate a raining effect to realize a unique visual effect. A plurality of lenses 15 are attached to a circular plastic mirror wheel 13, and a stepping motor drives the plastic mirror wheel 13 to form rotation. A laser beam is reflected through the lenses 15 and projected onto the grating 26 to form a plurality of laser beams. The stepping motor drives the plastic mirror wheel 13 to rotate so that the laser beams move from top to bottom. When the laser beam reaches the bottom, the laser beam is projected onto the next lens to start the process of the next laser beam from top to bottom, thereby finally realizing a unique visual effect of laser raining.

The present disclosure is simple and reasonable in structural design, is convenient and quick in operation and is high in practicality. The device is used to simulate a raining effect to realize a unique visual effect. A plurality of lenses are attached to a circular plastic mirror wheel, and a stepping motor drives the plastic mirror wheel to form rotation. A laser beam is reflected through the lenses and projected onto the grating to form a plurality of laser beams. The stepping motor drives the plastic mirror wheel to rotate so that the laser beams move from top to bottom. When the laser beam reaches the bottom, the laser beam is projected onto the next lens to start the process of the next laser beam from top to bottom, thereby finally realizing a unique visual effect of laser raining. The device can realize intelligent frequency conversion, and can save power.

For those skilled in the art, apparently, the present disclosure is not limited to details of the above demonstrative embodiments. Moreover, the present disclosure can be realized in other specific forms without departing from the spirit or basic feature of the present disclosure. Therefore, in all respects, the embodiments shall be regarded to be demonstrative and nonrestrictive. The scope of the present disclosure is defined by appended claims, rather than the above description. Therefore, the present disclosure is intended to include all changes falling into the meaning and the scope of equivalent elements of claims within the present disclosure. Any drawing mark in claims shall not be regarded to limit the concerned claims.

In addition, it shall be understood that although the description is explained in accordance with the embodiments, not every embodiment only includes one independent technical solution. This narration mode of the description is only for clarity. Those skilled in the art shall regard the description as a whole, and the technical solution in each embodiment can also be appropriately combined to form other embodiments understandable for those skilled in the art.

What is claimed is:

1. An intelligent variable frequency laser rain, comprising a back cover (5), a gluey shell (8), a radiator (20) and a front cover (27), wherein a contact (1) and a button (4) are arranged on the back cover (5); the button (4) is arranged in the middle of the back cover (5); a button back cover (6) is arranged at the right end of the button (4); the button back cover (6) is connected with a master control board (7); the back cover (5) and the gluey shell (8) are fixedly connected through a plurality of screws A (3); a rubber plug (2) is arranged on the screws A (3); a waterproof rubber ring (17) is arranged at the right end of the gluey shell (8); an elastic sheet (24) is arranged between the waterproof rubber ring (17) and the gluey shell (8); the radiator (20) is arranged at the right end of the gluey shell (8); a supporting frame A(11) and a supporting frame B(16) are arranged in the radiator (20); a rubber gear (12) is arranged on the supporting frame A(11); the rubber gear (12) is connected with a motor (14); a bearing (10) is arranged on the supporting frame A(11); the bearing (10) is fixedly connected with the supporting frame A(11) through a screw C(9); a mirror wheel (13) is arranged on the bearing (10); a plurality of lenses (15) are arranged on the mirror wheel (13); the mirror wheel (13) is fixedly connected with the supporting frame B(16); a reflecting lens bracket (22) is arranged in the radiator (20); a reflecting lens (21) is arranged on the reflecting lens bracket (22); an laser (23) is arranged at the left side of the reflecting lens bracket (22); the front cover (26) is arranged at the right end of the radiator (20); and a grating (25) is arranged in the front cover (26).

2. The intelligent variable frequency laser rain according to claim 1, wherein the waterproof rubber ring (17) is arranged between the radiator (20) and the front cover (26).

3. The intelligent variable frequency laser rain according to claim 1, wherein the radiator (20) and the front cover (26) are fixedly connected through a screw B(18) and a screw D(19).

4. The intelligent variable frequency laser rain according to claim 1, wherein corresponding gears are arranged on the rubber gear (12) and the mirror wheel (13).

5. The intelligent variable frequency laser rain according to claim 1, wherein a plurality of wrinkled raised lines are arranged on the radiator (20).

6. The intelligent variable frequency laser rain according to claim 1, wherein the motor (14) is configured as a stepping motor.
